(19) United States
(12) Patent Application Publication
(10) Pub. No.: US 2011/0246919 A1
(43) Pub. Date: Oct. 6, 2011

(54) SEARCH SYSTEM AND METHOD

(75) Inventors: Jong Woo JUNG, Hwaseong-si (KR); In Sik MYUNG, Incheon (KR); Joo Kyung WOO, Yongin-si (KR)

(73) Assignee: SAMSUNG ELECTRONICS CO., LTD., Suwon-si (KR)

(21) Appl. No.: 12/850,671

(22) Filed: Aug. 5, 2010

(30) Foreign Application Priority Data
Apr. 1, 2010 (KR) 10-2010-0029943

(51) Int. Cl. G06F 17/30; G06F 3/048

(52) U.S. Cl. 715/769; 707/722; 707/E17.014

(57) ABSTRACT

A search system and method are provided. A search result window for search information may be generated and displayed based on a size of a drag area and thus, it is possible for a user to select an amount of search information, a user interface, and an information type.

### CROSS-REFERENCE TO RELATED APPLICATION(S)

This application claims the benefit under 35 U.S.C. §119(a) of Korean Patent Application No. 10-2010-0029943, filed on Apr. 1, 2010, in the Korean Intellectual Property Office, the entire disclosure of which is incorporated herein by reference.

### BACKGROUND

1. Field

The following description relates to a search system and method, and more particularly, to a system and method that may provide search information for a text using a drag interaction.

2. Description of Related Art

With the recent proliferation of Internet technologies, searching for information has been frequently employed and used in everyday life, as well as in professional fields.

Among currently available search services, the most common scheme may enable a user to input a desired text in a search window, so that search information for the input text may be displayed.

In such a conventional search service, a user may receive a search result provided by manually inputting a search term in a search window, or copying and pasting the search term. Additionally, since it is impossible for a user to select a desired amount of search results, a desired user interface or an information type of search information, he or she inevitably receives all relevant search information provided based on a user interface and information amount that are set in advance. Furthermore, search information the user does not desire is also provided and thus, resources of networks or user terminals are wasted.

### SUMMARY

In one general aspect, there is provided a search system, comprising: a receiver configured to receive, from a search server, search information for a dragged text; a generator configured to generate a search result window for the search information, based on a size of a drag area; and a display unit configured to display the search result window on the drag area.

The search system may further include: a database configured to store at least one user interface; and a determiner configured to determine a first user interface corresponding to the size of the drag area among the at least one user interface, wherein the generator is further configured to generate the search result window using the first user interface.

The search system may further include: a determiner configured to determine an information type of the search information based on the size of the drag area, wherein the generator is further configured to generate the search result window for first search information corresponding to the determined information type among the search information.

The search system may further include that the information type comprises at least one of: text information, image information, thumbnail information, audio information, and moving image information.

In another general aspect, there is provided a search system, comprising: a determiner configured to determine an information type of search information for a dragged text, based on a size of a drag area; a receiver configured to receive, from a search server, first search information corresponding to the determined information type among the search information; a generator configured to generate a search result window for the first search information, based on the size of the drag area; and a display unit configured to display the search result window on the drag area.

The search system may further include an information request unit configured to request the search server to transmit the first search information.

In another general aspect, there is provided a search method, comprising: receiving, from a search server, search information for a dragged text; generating a search result window for the search information, based on a size of a drag area; and displaying the search result window on the drag area.

The search method may further include: determining a first user interface corresponding to the size of the drag area among at least one user interface, the at least one user interface being stored in a database, wherein the generating comprises generating the search result window using the first user interface.

The search method may further include: determining an information type of the search information based on the size of the drag area, wherein the generating comprises generating the search result window for first search information corresponding to the determined information type among the search information.

In another general aspect, there is provided a search method, comprising: determining an information type of search information for a dragged text based on a size of a drag area; receiving, from a search server, first search information corresponding to the determined information type among the search information; generating a search result window for the first search information, based on the size of the drag area; and displaying the search result window on the drag area.

The search method may further include requesting the search server to transmit the first search information.

Also provided may be a non-transitory computer readable recording medium storing a program to cause a computer to implement the above methods.

Other features and aspects may be apparent from the following detailed description, the drawings, and the claims.

### BRIEF DESCRIPTION OF THE DRAWINGS

FIG. 1 is a diagram illustrating an example of a search system according to an embodiment.

FIG. 2 is a block diagram illustrating a configuration of a search system according to an embodiment.

FIG. 3 is a diagram illustrating an example in which search information is displayed based on a size of a drag area in a search system according to an embodiment.

FIG. 4 is a block diagram illustrating a configuration of a search system according to another embodiment.

FIG. 5 is a flowchart illustrating a search method according to an embodiment.

FIG. 6 is a flowchart illustrating a search method according to another embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses, and/or methods described herein will be suggested to those of ordinary skill in the art. The progression of processing steps and/or operations described is an example; however, the sequence of steps and/or operations is not limited to that set forth herein and may be changed as is known in the art, with the exception of steps and/or operations necessarily occurring in a certain order. Also, description of well-known functions and constructions may be omitted for increased clarity and conciseness.

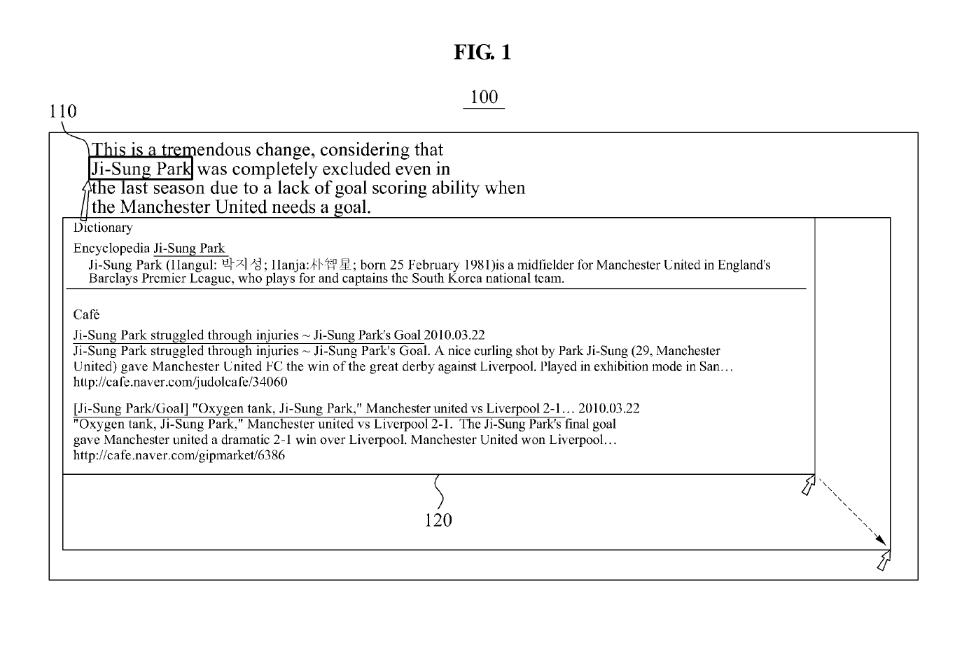

FIG. 1 illustrates an example of a search system according to an embodiment.

Referring to FIG. 1, when a user desires to search for information regarding a text 110, for example “Ji-Sung Park,” from a webpage 100 using a search system according to an embodiment, he or she may drag the cursor over the text 110 using an input device, e.g., a mouse.

For example, the search system may receive search information for the dragged text 110 from a search server.

When the text 110 is dragged, the user may further drag the cursor over a predetermined area of the webpage 100 using the input device, so that a drag area 120 may be generated. In other words, the drag area 120 may be an area generated when a user performs a dragging operation using the input device. The drag area 120 may be displayed in various forms, for example a rectangle, a circle or other forms, depending on a program execution environment.

When the drag area 120 is generated by the dragging operation, the search system may display the search information received from the search server in the drag area 120.

The search system may display search information based on a size of the drag area 120. For example, when the size of the drag area 120 is small, the search system may display only text information among the search information for the text 110 in the drag area 120. Additionally, when a user drags the cursor to a location far away from the drag area 120 to enlarge the drag area 120, the search system may display, in the drag area 120, image information and moving image information, as well as the text information.

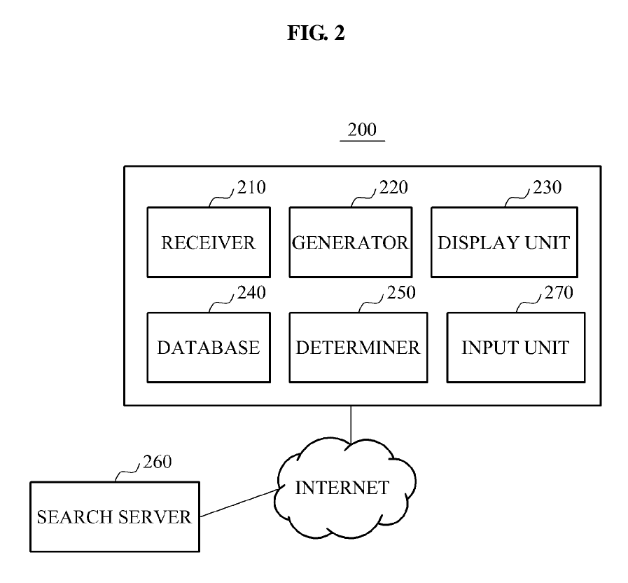

FIG. 2 illustrates a configuration of a search system 200 according to an embodiment.

Referring to FIG. 2, the search system 200 includes a receiver 210, a generator 220, and a display unit 230.

The receiver 210 may receive, from a search server 260, search information for a dragged text. For example, the receiver 210 may receive the search information through the Internet from the search server 260. The search information may be information collected by searching for the dragged text.

The generator 220 may generate a search result window for the search information, based on a size of a drag area. The search result window may be used to show the search information for the dragged text.

The generator 220 may filter the search information received from the search server 260 based on the size of the drag area, and may generate a search result window containing the filtered information.

Depending on embodiments, the generator 220 may generate a search result window, of which a font size, an image size, and an arrangement of search information are changed based on the size of the drag area.

The display unit 230 may display the search result window generated by the generator 220 on the drag area.

According to an embodiment, the search system 200 may further include a database 240, and a determiner 250.

The database 240 may store at least one user interface. Depending on embodiments, the database 240 may store information on the size of the drag area corresponding to the user interface, together with the user interface. Additionally, the database 240 may store information on a combination of the user interface and the size of the drag area. For example, a user interface A may be used when the size of the drag area is less than 10% of an entire screen area, and a user interface B may be used when the size of the drag area is equal to or greater than 10% and is less than 20% of the entire screen area.

The determiner 250 may determine a first user interface corresponding to the size of the drag area among the at least one user interface stored in the database 240.

In one example, the generator 220 may generate a search result window using the first user interface determined by the determiner 250.

For example, in response to user interfaces A, B, and C being stored in the database 240, and the drag area occupying 20% of the entire screen, the determiner 250 may determine the user interface A as the first user interface used to generate a search result window, among the user interfaces A, B, and C. Subsequently, the generator 220 may generate a search result window using the user interface A.

Depending on embodiments, the search system 200 may further include an input unit 270.

The input unit 270 may receive an input of a reference value for the size of the drag area corresponding to the user interface stored in the database 240. For example, the input unit 270 may receive an input of “the size of the drag area less than 20% of the entire screen” as a reference value that is used to determine the user interface A to be the first user interface among the user interfaces A, B, and C stored in the database 240.

According to another embodiment, the determiner 250 may determine an information type of the search information received by the receiver 210 from the search server 260, based on the size of the drag area.

The information type may be a type of the search information for the dragged text. Depending on embodiments, the information type may include at least one of text information, image information, thumbnail information, audio information, and moving image information.

For example, the generator 220 may generate a search result window for first search information corresponding to the information type determined by the determiner 250. Depending on embodiments, when the determiner 250 determines the information type to be image information based on the size of the drag area, the generator 220 may generate a search result window for the image information among the search information. In other words, the search result window generated by the generator 220 may contain the image information.

Depending on embodiments, when a user slightly drags cursor to generate a small drag area, the search system may display, in the drag area, only text information regarding texts among the search information, based on the size of the drag area. For example, the determiner 250 may determine the information type of the search information to be text information. Additionally, the generator 220 may generate a search result window for the text information, and the display unit 230 may display the generated search result window for the text information on the drag area.

When the user continues to drag cursor to enlarge the drag area, the search system may display, in the drag area, the text information and image information regarding images among the search information, based on the size of the drag area. For example, the determiner 250 may determine the information type of the search information to be text information and image information. Additionally, the generator 220 may generate a search result window for the text information and the image information, and the display unit 230 may display the generated search result window for the text information and the image information on the drag area.

Depending on embodiments, the search system 200 may further include an input unit 270.

The input unit 270 may receive an input of a reference value for the size of the drag area that is used to determine the information type of the search information. For example, the input unit 270 may receive an input of “the size of the drag area equal to or greater than 80% of the entire screen” as a reference value that is used to determine first search information associated with the search result window to be moving image information.

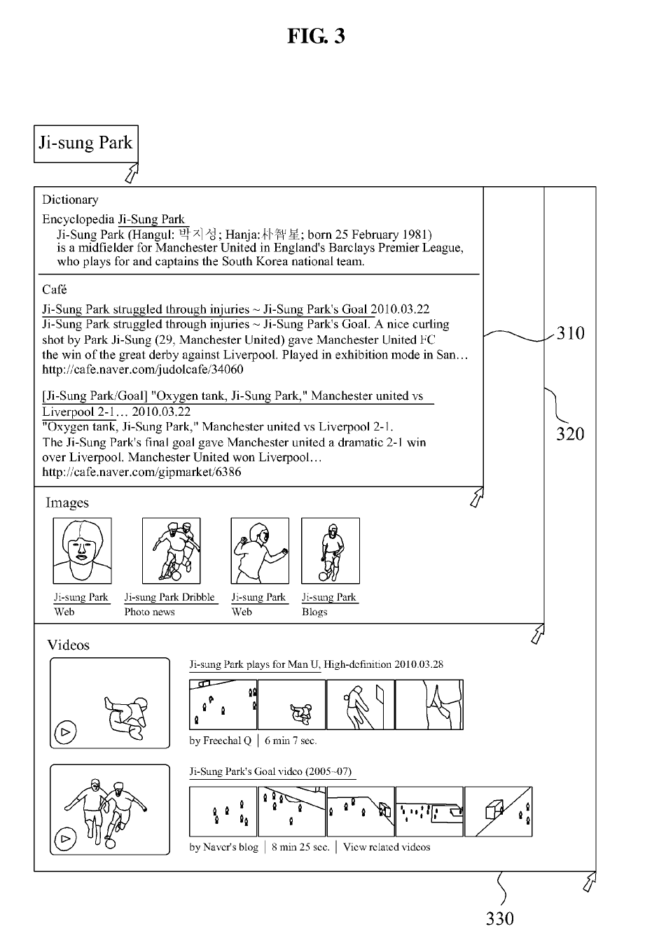

FIG. 3 illustrates an example in which search information is displayed based on a size of a drag area in a search system according to an embodiment.

Referring to FIG. 3, the search system may receive, from a search server, search information for a text dragged by a user, for example “Ji-Sung Park,” and may display the received search information on drag areas 310, 320, and 330.

For example, when the user slightly drags the cursor over the text “Ji-Sung Park” to generate the drag area 310, the search system may display only text information among the search information for “Ji-Sung Park” in the drag area 310.

Additionally, when the user further drags the drag area 310 to generate the drag area 320 having a greater size than the drag area 310, the search system may further display image information together with the text information among the search information for “Ji-Sung Park” in the drag area 320.

Furthermore, when the user further drags the cursor over the drag area 320 to generate the drag area 330 having a greater size than the drag area 320, the search system may further display moving image information together with the text information and the image information among the search information for “Ji-Sung Park” in the drag area 330.

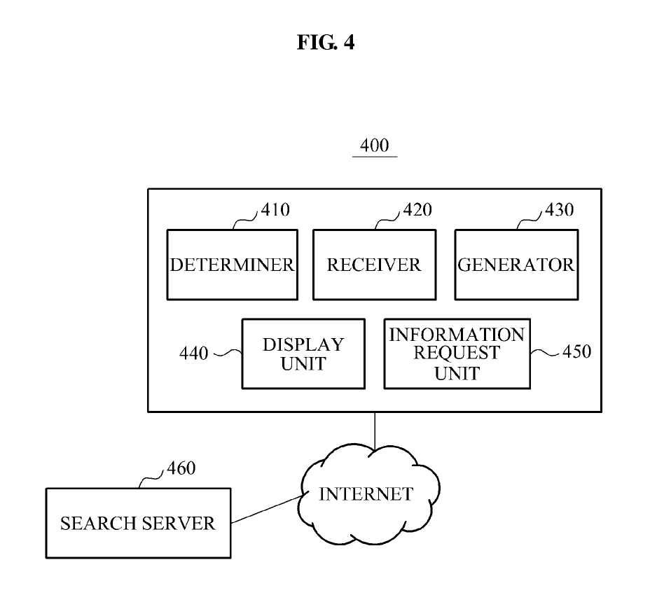

FIG. 4 illustrates a configuration of a search system 400 according to another embodiment.

Referring to FIG. 4, the search system 400 may include a determiner 410, a receiver 420, a generator 430, and a display unit 440.

The determiner 410 may determine an information type of search information for a dragged text, based on a size of a drag area. For example, the drag area may be generated by the dragging operation.

Depending on embodiments, when a user generates a drag area having a size less than 10% of the entire screen, the determiner 410 may determine the information type of the search information to be text information.

According to an embodiment, the search system 400 may further include an information request unit 450. The information request unit 450 may request a search server 460 to transmit first search information determined by the determiner 410.

Depending on embodiments, the information request unit 450 may request the search server 460 to transmit only text information among the search information.

The receiver 420 may receive, from the search server 460, first search information corresponding to the information type determined by the determiner 410, among the search information for the dragged text.

Depending on embodiments, the receiver 420 may receive only text information from the search server 460, among search information for a text dragged by a user.

The generator 430 may generate a search result window for the first search information, based on the size of the drag area.

Depending on embodiments, the generator 430 may generate a search result window for text information. In other words, the generated search result window may contain only the text information.

The display unit 440 may display the search result window generated by the generator 430 on the drag area.

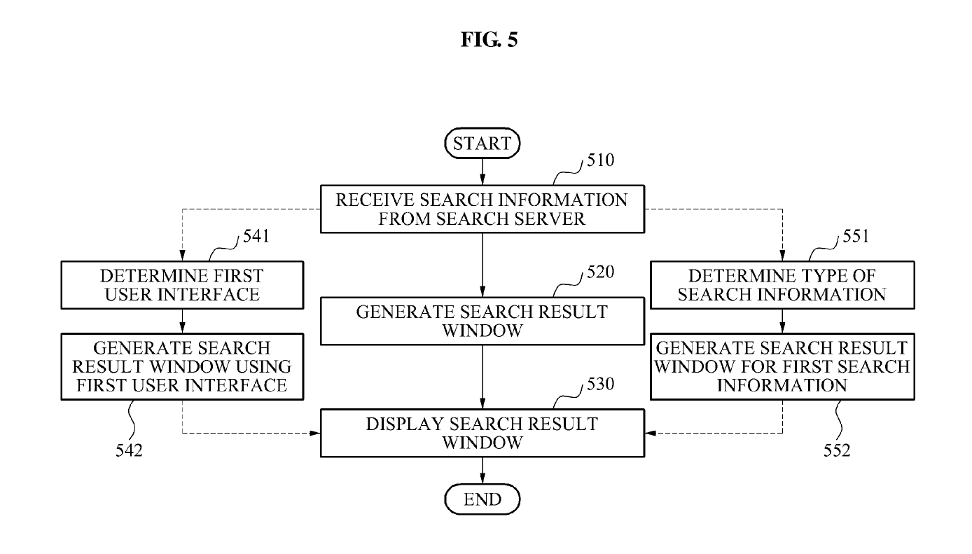

FIG. 5 illustrates a flowchart of a search method according to an embodiment.

Referring to FIG. 5, search information for a dragged text may be received from a search server in operation 510. For example, the search information may be received through the Internet from the search server, and may be information collected by searching for the dragged text.

In operation 502, a search result window for the search information may be generated based on a size of a drag area. The search result window may be used to show the search information for the dragged text.

The search information received from the search server may be filtered based on the size of the drag area, and a search result window containing the filtered information may be generated.

Depending on embodiments, a search result window, of which a font size, an image size, and an arrangement of search information are changed based on the size of the drag area, may be generated.

In operation 530, the search result window may be displayed on the drag area. In operation 541, a first user interface corresponding to the size of the drag area may be determined among at least one user interface stored in a database. In operation 542, a search result window may be generated using the determined first user interface.

Depending on embodiments, the database may store information on the size of the drag area corresponding to the user interface, together with the user interface. Additionally, the database may store information on a combination of the user interface and the size of the drag area. For example, a user interface A may be used when the size of the drag area is less than 10% of an entire screen area, and a user interface B may be used when the size of the drag area is equal to or greater than 10% and is less than 20% of the entire screen area.

For example, when user interfaces A, B, and C are stored in the database, and when the drag area occupies 20% of the entire screen area, the user interface A may be determined as the first user interface used to generate a search result window, among the user interfaces A, B, and C. Subsequently, a search result window may be generated using the user interface A.

Depending on embodiments, an input of a reference value for the size of the drag area corresponding to the user interface stored in the database may be received. For example, an input of “the size of the drag area less than 20% of the entire screen” may be received as a reference value that is used to determine the user interface A to be the first user interface among the user interfaces A, B, and C stored in the database.

In operation 551, an information type of the search information received from the search server may be determined based on the size of the drag area.

The information type may be a type of the search information for the dragged text. Depending on embodiments, the information type may include at least one of text information, image information, thumbnail information, audio information, and moving image information.

Additionally, a search result window for first search information corresponding to the determined information type may be generated. Depending on embodiments, when the information type is determined to be image information based on the size of the drag area, a search result window for the image information among the search information may be generated. In other words, the generated search result window may contain the image information.

Depending on embodiments, when a user slightly drags cursor to generate a small drag area, only text information regarding text among the search information may be displayed in the display area, based on the size of the drag area. For example, the information type of the search information may be determined to be text information. Additionally, a search result window for the text information may be generated, and the generated search result window for the text information may be displayed on the drag area.

When the user continues to drag cursor to enlarge the drag area, the text information and image information regarding images among the search information may be displayed in the drag area based on the size of the drag area. For example, the information type of the search information may be determined to be text information and image information. Additionally, a search result window for the text information and the image information may be generated, and the generated search result window for the text information and the image information may be displayed on the drag area.

Depending on embodiments, an input of a reference value for the size of the drag area may be received. For example, the size of the drag area may be used to determine the information type of the search information. For example, an input of “the size of the drag area equal to or greater than 80% of the entire screen” may be received as a reference value that is used to determine first search information associated with the search result window to be moving image information.

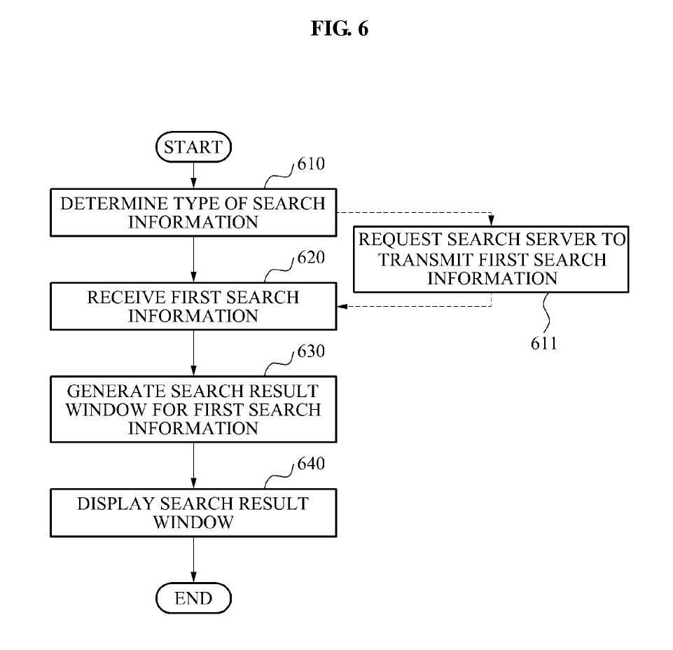

FIG. 6 illustrates a flowchart of a search method according to another embodiment.

Referring to FIG. 6, an information type of search information for a dragged text may be determined based on a size of a drag area in operation 610.

Depending on embodiments, when a user generates a drag area having a size less than 10% of the entire screen area, the information type of the search information may be determined to be text information.

In operation 611, a request for first search information may be sent to a search server. For example, the first search information may be determined by the search method, and may be requested.

Depending on embodiments, a request for only text information among the search information may be sent to the search server.

In operation 620, first search information corresponding to the determined information type may be received from the search server.

Depending on embodiments, only text information among search information for a text dragged by a user may be received from the search server.

In operation 630, a search result window for the first search information may be generated based on the size of the drag area.

In the search method, the search information received from the search server may be filtered based on the size of the drag area, and a search result window containing the filtered information may be generated.

Depending on embodiments, a search result window, of which a font size, an image size, and an arrangement of search information are changed based on the size of the drag area, may be generated.

Depending on embodiments, a search result window for text information may be generated. In other words, the generated search result window may contain only the text information.

In operation 640, the search result window may be displayed on the drag area. The processes, functions, methods and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media, such as hard disks, floppy disks, and magnetic tape; optical media such as CD-ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer.

It will be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A search system, comprising:
a receiver configured to receive, from a search server, search information for a dragged text;
a generator configured to generate a search result window for the search information, based on a size of a drag area; and
a display unit configured to display the search result window on the drag area.

2. The search system of claim 1, further comprising:
a database configured to store at least one user interface; and
a determiner configured to determine a first user interface corresponding to the size of the drag area among the at least one user interface,
wherein the generator is further configured to generate the search result window using the first user interface.

3. The search system of claim 1, further comprising:
a determiner configured to determine an information type of the search information based on the size of the drag area,
wherein the generator is further configured to generate the search result window for first search information corresponding to the determined information type among the search information.

4. The search system of claim 3, wherein the information type comprises at least one of: text information, image information, thumbnail information, audio information, and moving image information.

5. A search system, comprising:
a determiner configured to determine an information type of search information for a dragged text, based on a size of a drag area;
a receiver configured to receive, from a search server, first search information corresponding to the determined information type among the search information;
a generator configured to generate a search result window for the first search information, based on the size of the drag area; and
a display unit configured to display the search result window on the drag area.

6. The search system of claim 5, further comprising an information request unit configured to request the search server to transmit the first search information.

7. A search method, comprising:
receiving, from a search server, search information for a dragged text;
generating a search result window for the search information, based on a size of a drag area; and
displaying the search result window on the drag area.

8. The search method of claim 7, further comprising:
determining a first user interface corresponding to the size of the drag area among at least one user interface, the at least one user interface being stored in a database,
wherein the generating comprises generating the search result window using the first user interface.

9. The search method of claim 7, further comprising:
determining an information type of the search information based on the size of the drag area,
wherein the generating comprises generating the search result window for first search information corresponding to the determined information type among the search information.

10. A search method, comprising:
determining an information type of search information for a dragged text based on a size of a drag area;
receiving, from a search server, first search information corresponding to the determined information type among the search information;
generating a search result window for the first search information, based on the size of the drag area; and
displaying the search result window on the drag area.

11. The search method of claim 10, further comprising requesting the search server to transmit the first search information.

12. A non-transitory computer readable recording medium storing a program to cause a computer to implement the method of claim 7.
